(19) United States
(12) Patent Application Publication
(10) Pub. No.: US 2020/0234320 A1
(43) Pub. Date: Jul. 23, 2020

(54) INFORMATION PROCESSING APPARATUS, INFORMATION PROCESSING METHOD, PROGRAM, AND DEMAND SEARCH SYSTEM

(71) Applicant: TOYOTA JIDOSHA KABUSHIKI KAISHA, Toyota-shi (JP)

(72) Inventors: Hiromichi DOGISHI, Nagoya-shi (JP); Masaki SHITARA, Nagakute-shi (JP); Keiji YAMASHITA, Nisshin-shi (JP); Nozomi KANEKO, Nagoya-shi (JP); Naoki YAMAMURO, Nagoya-shi (JP); Shunsuke TANIMORI, Susono-shi (JP); Ryoichi SHIRAISHI, Anjo-shi (JP)

(73) Assignee: TOYOTA JIDOSHA KABUSHIKI KAISHA, Toyota-shi (JP)

(21) Appl. No.: 16/708,637

(22) Filed: Dec. 10, 2019

(30) Foreign Application Priority Data
Jan. 23, 2019 (JP) 2019-009409

(51) Int. Cl. G06Q 30/02; G06Q 10/06; G05D 1/00

(52) U.S. Cl. CPC G06Q 30/0205; G06Q 30/0245; G05D 1/0094; G06Q 10/06315; G05D 1/0088; G06Q 30/0266

(57) ABSTRACT

An information processing apparatus includes a controller configured to determine the demand of a consumer for a product based on a behavior of the consumer that is detected in a moving object and store the result of the determination about the demand into a storage unit with the result of the determination being correlated with the predetermined place, the moving object being configured to autonomously travel based on an operation instruction and move the product or an advertisement for the product to a predetermined place.

### INCORPORATION BY REFERENCE

The disclosure of Japanese Patent Application No. 2019-009409 filed on Jan. 23, 2019 including the specification, drawings and abstract is incorporated herein by reference in its entirety.

### BACKGROUND

### 1. Technical Field

The disclosure relates to an information processing apparatus, an information processing method, a program, and a demand search system.

### 2. Description of Related Art

There is a known system in which whether delivery of package can be performed by an autonomously traveling moving object or not is checked when a package delivery method performed by the autonomously traveling moving object is designated (for example, refer to Japanese Unexamined Patent Application Publication No. 2018-124676 (JP 2018-124676 A).

### SUMMARY

The disclosure provides an information processing apparatus, an information processing method, a program, and a demand search system with which it is possible to search for the demand for a product by using an autonomously traveling moving object.

A first aspect of the disclosure relates to an information processing apparatus comprising a controller. The controller is configured to determine the demand of a consumer for a product based on a behavior of the consumer that is detected in a moving object configured to autonomously travel based on an operation instruction and move the product or an advertisement for the product to a predetermined place and store the result of the determination about the demand into a storage unit with the result of the determination being correlated with the predetermined place.

A second aspect of the disclosure relates to an information processing method. The information processing method includes determining the demand of a consumer for a product based on a behavior of the consumer that is detected in a moving object configured to autonomously travel based on an operation instruction and move the product or an advertisement for the product to a predetermined place and storing the result of the determination about the demand into a storage unit with the result of the determination being correlated with the predetermined place.

A third aspect of the disclosure relates to a program. The program causes a computer to determine the demand of a consumer for a product based on a behavior of the consumer that is detected in a moving object configured to autonomously travel based on an operation instruction and move the product or an advertisement for the product to a predetermined place and store the result of the determination about the demand into a storage unit with the result of the determination being correlated with the predetermined place.

A fourth aspect of the disclosure relates to a demand search system including a moving object and a server. The moving object is configured to autonomously travel based on an operation instruction and move a product or an advertisement for the product to a predetermined place. The server is configured to output the operation instruction to the moving object. The moving object is provided with a behavior detection device configured to detect a behavior of a consumer and a position detection device configured to detect position information of the moving object. The server is provided with a demand determination unit configured to determine the demand of the consumer for the product based on the behavior of the consumer that is detected by the behavior detection device and a storage unit configured to store the result of the determination performed by the demand determination unit with the result of the determination being correlated with the position information of the moving object that is detected by the position detection device.

According to the aspects of the disclosure, it is possible to search for the demand for a product by using an autonomously traveling moving object.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating a schematic configuration of an autonomous driving system according to an embodiment;

FIG. 2 is a diagram for describing the inside of a vehicle;

FIG. 3 is a block diagram schematically illustrating an example of the configurations of the vehicle and a server constituting the autonomous driving system according to the embodiment;

FIG. 4 is a diagram illustrating an example of the functional configuration of the server;

FIG. 5 is a diagram illustrating a table configuration of image information;

FIG. 6 is a diagram illustrating a table configuration of demand information;

FIG. 7 is a diagram illustrating an example of the functional configuration of the vehicle;

FIG. 8 is an example of a flowchart of a process of creating demand information DB according to present embodiment; and

FIG. 9 is an example of a flowchart of a process in the vehicle according to the embodiment.

### DETAILED DESCRIPTION OF EMBODIMENTS

A moving object controlled by an information processing apparatus according to an embodiment is a vehicle that autonomously travels based on an operation instruction. The operation instruction includes an instruction to move to a predetermined place (for example, location of consumer). A controller determines the demand of a consumer based on the detected behavior of the consumer. Examples of the detected behavior of the consumer include the number of times that the consumer touches a product, the length of a time for which the consumer touches a product, the number of times that the consumer sees a product or an advertisement for the product, the length of a time for which the consumer sees a product or an advertisement for the product, the heart rate of the consumer, the body temperature of the consumer, and the length of a time for which the consumer stays in front of a product or an advertisement for the product. Those above described relate to the demand of the consumer. Those above described are measured through a sensor, for example. The product is not limited to an article and examples thereof can include a service.

For example, the longer the length of a time for which the consumer continues to see a product is, the more the consumer can be determined as being interested in the product. Therefore, the longer the length of a time for which the consumer continues to see a product, the higher the controller determines the demand for the product as being. A relationship between a behavior of the consumer and the demand of the consumer for a product may be determined in advance. In addition, the controller stores the result of the determination about demand into a storage unit with the result of the determination about demand being correlated with the predetermined place. Information about the predetermined place may be acquired from position information of the moving object and may be acquired from the operation instruction. Since the result of the determination about demand and the predetermined place are stored while being correlated with each other, it is possible to accumulate the results of determination about demand for products at the predetermined place or an area including the place. Therefore, it is possible to sell a product for which the demand is high at the predetermined place or the area including the predetermined place first and thus it is possible to increase the sales.

Note that, the controller may store the result of determination about demand into a storage unit with the result of the determination about demand being correlated with a time in addition to the predetermined place. Since the demand for a product may change depending on the time as well, when the result of determination about demand is stored while being correlated with a time also, determination about demand can be made more specifically. In addition, for example, the result of determination about demand may be stored in the storage unit with the result of determination about demand being correlated with a season, a day of the week, weather, or the like.

The controller may determine the demand based on the behavior of the consumer imaged by a camera provided in the moving object. Since it is possible to obtain the number of times that the consumer touches a product, the length of a time for which the consumer touches a product, the number of times that the consumer sees a product, the length of a time for which the consumer sees a product, or the like by analyzing an image (moving image or still image) captured by the camera, it is possible to determine the demand.

Hereinafter, embodiments will be described based on drawings. The configurations in the following embodiments are merely examples and the disclosure is not limited to the configurations in the embodiments. In addition, the following embodiments can be combined with each other as much as possible.

### First Embodiment

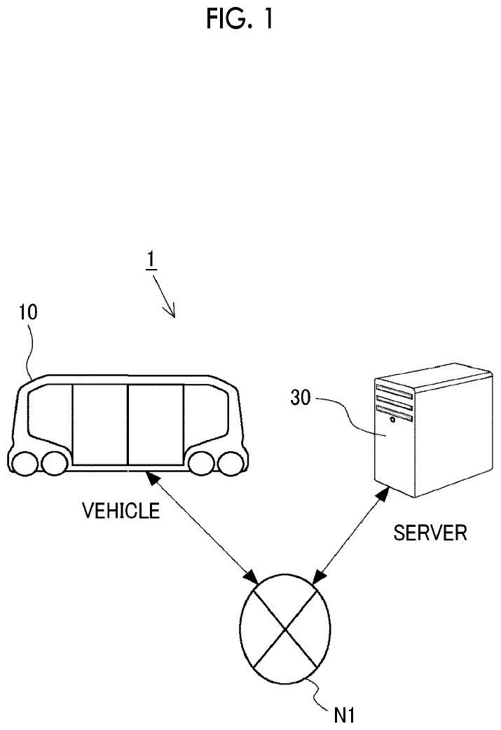

FIG. 1 is a diagram illustrating a schematic configuration of an autonomous driving system 1 according to an embodiment. A vehicle 10 autonomously travels in accordance with an operation instruction generated by a server 30. The autonomous driving system 1 shown in FIG. 1 is a system in which the vehicle 10, on which a product or an advertisement for an article is placed, travels to the location of a consumer (predetermined place), and exhibits or sells the article or displays the advertisement to the consumer and the demand of the consumer for the product is determined.

The autonomous driving system 1 includes, for example, the vehicle 10 and the server 30. Note that, the number of vehicles 10 may not be one as shown in FIG. 1 and the number of vehicles 10 may be two or more. The vehicle 10 includes equipment with which it is possible to transport an article installed therein or to travel while displaying an advertisement for an article or a service. For example, in the case of the vehicle 10 on which a plurality of curtains is installed as products, the curtains are exhibited in a state similar to a state in a situation where the curtains are actually used. For examples, in the case of a curtain or the like, it is possible to roughly figure out the color thereof or the like by seeing a catalog but it is difficult to know the texture thereof or how the curtain looks when the curtain is actually attached. Therefore, when the vehicle 10 exhibits the curtains such that a consumer sees the curtains, the consumer can check the texture or the like thereof. Hereinafter, a case where the curtains are exhibited inside the vehicle 10 will be described.

The vehicle 10 and the server 30 are connected to each other via a network N1. The network N1 is a global public communication network such as the Internet and a wide area network (WAN) or other communication networks can be adopted as the network N1. In addition, the network N1 may include a telephone communication network for a cellular phone or the like and a wireless communication network such as WiFi.

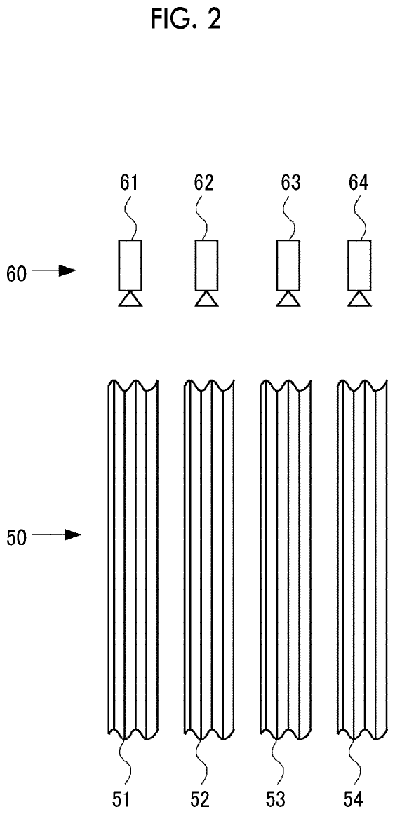

The vehicle 10 is a vehicle provided with a space in which a curtain can be exhibited. The vehicle 10 is provided with a camera that detects the behavior of a consumer inside the vehicle 10. The camera includes an imaging sensor. FIG. 2 is a diagram for describing the inside of the vehicle 10. As shown in FIG. 2, inside the vehicle 10, a plurality of curtains 51, 52, 53, 54 is exhibited. Note that, hereinafter, the curtains 51, 52, 53, 54 will be simply referred to as “curtains 50” in a case where the curtains 51, 52, 53, 54 are not distinguished. The curtains 50 are respectively provided with cameras 61, 62, 63, 64 that respectively image the vicinities of the curtains 50. Note that, hereinafter, the cameras 61, 62, 63, 64 will be simply referred to as “cameras 60” in a case where the cameras 61, 62, 63, 64 are not distinguished. Each camera 60 is installed such that the camera 60 can image a consumer touching the corresponding curtain 50.

In addition, the vehicle 10 transmits position information, which indicates the current position of the vehicle 10, to the server 30 periodically or in response to a request from the server 30. In addition, the vehicle 10 transmits data of images captured by the cameras 60 (hereinafter, also referred to as image data) to the server 30 with the data of the images being correlated with the position information. The vehicle 10 transmits the position information and the image data to the server 30 along with identification information (vehicle ID) for uniquely identifying the vehicle 10. Note that, a vehicle ID for identifying the vehicle 10 is assigned in advance.

The server 30 searches for the demand for the curtain 50 at a position indicated by the position information based on the position information and the image data. For example, the server 30 counts the number of times that a consumer touches the curtain 50 based on the images captured by the cameras 60 and determines the demand for the curtain 50 corresponding to the number. For example, the larger the number of times that the consumer touches the curtain 50 is, the higher the demand for the curtain 50 is determined as being. The server 30 determines the demand for each curtain 50 and stores the demand for each curtain 50 along with the position information. At this time, information about a time (time information) may also be stored while being correlated with the demand for each curtain 50.

Hardware Configuration

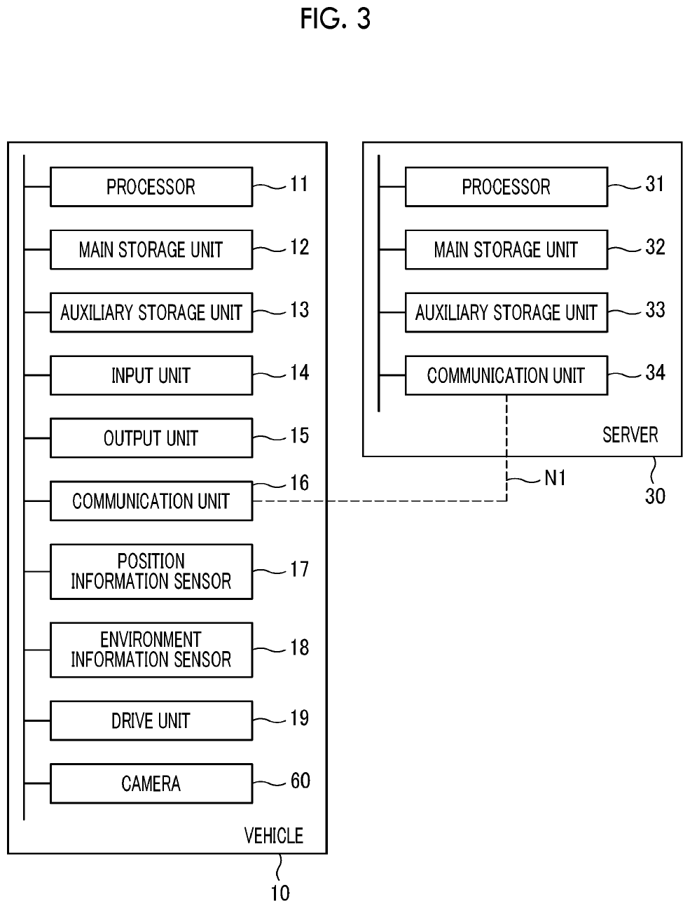

The hardware configurations of the vehicle 10 and the server 30 will be described based on FIG. 3. FIG. 3 is a block diagram schematically illustrating an example of the configurations of the vehicle 10 and the server 30 constituting the autonomous driving system 1 according to the present embodiment.

The server 30 has a configuration like that of a general computer. The server 30 includes a processor 31, a main storage unit 32, an auxiliary storage unit 33, and a communication unit 34. These are connected to each other via a bus.

The processor 31 is a central processing unit (CPU), a digital signal processor (DSP), or the like. The processor 31 controls the server 30 and performs calculation of various kinds of information processing. The processor 31 is an example of “controller”. The main storage unit 32 is a random access memory (RAM), a read only memory (ROM), or the like. The auxiliary storage unit 33 is an erasable programmable ROM (EPROM), a hard disk drive (HDD), a removable media, or the like. In the auxiliary storage unit 33, an operating system (OS), various programs, various tables, and the like are stored. The auxiliary storage unit 33 is an example of “storage unit”. The processor 31 loads the programs stored in the auxiliary storage unit 33 onto a work area of the main storage unit 32 and executes the programs and each component or the like is controlled through execution of the programs. Accordingly, a function matching a predetermined object is realized by the server 30. The main storage unit 32 and the auxiliary storage unit 33 are computer-readable recording mediums. Note that, the server 30 may be a single computer and may be a plurality of computers linked to each other. In addition, information stored in the auxiliary storage unit 33 may be stored in the main storage unit 32. In addition, information stored in the main storage unit 32 may be stored in the auxiliary storage unit 33.

The communication unit 34 is means for communicating with the vehicle 10 via the network N1. The communication unit 34 is, for example, a local area network (LAN) interface board or a wireless communication circuit for wireless communication. The LAN interface board or the wireless communication circuit is connected to the network N1.

Note that, a series of processes performed in the server 30 may be performed by means of a hardware and may be performed by means of software. The hardware configuration of the server 30 is not limited to that shown in FIG. 3. In addition, a part or all of the components of the server 30 may be installed in the vehicle 10.

Next, the vehicle 10 will be described. The vehicle 10 includes a processor 11, a main storage unit 12, an auxiliary storage unit 13, an input unit 14, an output unit 15, a communication unit 16, a position information sensor 17, an environment information sensor 18, a drive unit 19, and the cameras 60. These are connected to each other via a bus. Since the processor 11, the main storage unit 12, and the auxiliary storage unit 13 are the same as the processor 31, the main storage unit 32, and the auxiliary storage unit 33 of the server 30, the description thereof will be omitted.

The input unit 14 is means for receiving an input operation performed by a user and is, for example, a touch panel, a push button, or the like. The output unit 15 is means for presenting information to a user and is, for example, a liquid crystal display (LCD), an electroluminescence (EL) panel, a speaker, a lamp, or the like. The input unit 14 and the output unit 15 may be configured as one touch panel display. A user using the vehicle 10 or a user managing the vehicle 10 can use the input unit 14 and the output unit 15, for example. The communication unit 16 is communication means for connecting the vehicle 10 to the network N1. The communication unit 16 is a circuit for communicating with another device (for example, server 30) via the network N1 by means of a mobile communication service (telephone communication network such as 3rd Generation (3G) and long term evolution (LTE) and wireless communication such as WiFi).

The position information sensor 17 acquires position information (latitude and longitude, for example) of the vehicle 10 each time a predetermined period elapses. The position information sensor 17 is, for example, a global positioning system (GPS) receiver, a WiFi communication unit, or the like. Information acquired by the position information sensor 17 is recorded in the auxiliary storage unit 13 or the like and is transmitted to the server 30. Note that, a time at which position information is acquired may also be transmitted to the server 30 while being correlated with the position information.

The environment information sensor 18 is means for sensing the state of the vehicle 10 or sensing the vicinity of the vehicle 10. Examples of a sensor for sensing the state of the vehicle 10 include an acceleration sensor, a speed sensor, and an azimuth sensor. Examples of a sensor for sensing the vicinity of the vehicle 10 include a stereo camera, a laser scanner, a LIDAR device, and a radar.

The drive unit 19 causes the vehicle 10 to travel based on a control instruction generated by the processor 11. The drive unit 19 is configured to include, for example, a motor or an inverter, a brake, a steering mechanism and the like for driving vehicle wheels of the vehicle 10 and autonomous travel of the vehicle 10 is realized with the motor, the brake, or the like being driven in accordance with the control instruction.

The cameras 60 are provided in the vehicle 10 and image the vicinities of the curtains 50 exhibited inside the vehicle 10. Each camera 60 is a camera that captures an image by using an imaging element such as charge coupled device (CCD) image sensor and a complementary metal oxide semiconductor (CMOS) image sensor. A captured image may be any of a still image and a moving image. A captured image is transmitted to the server 30 along with position information after the captured image is stored in the auxiliary storage unit 13.

Functional Configuration: Server

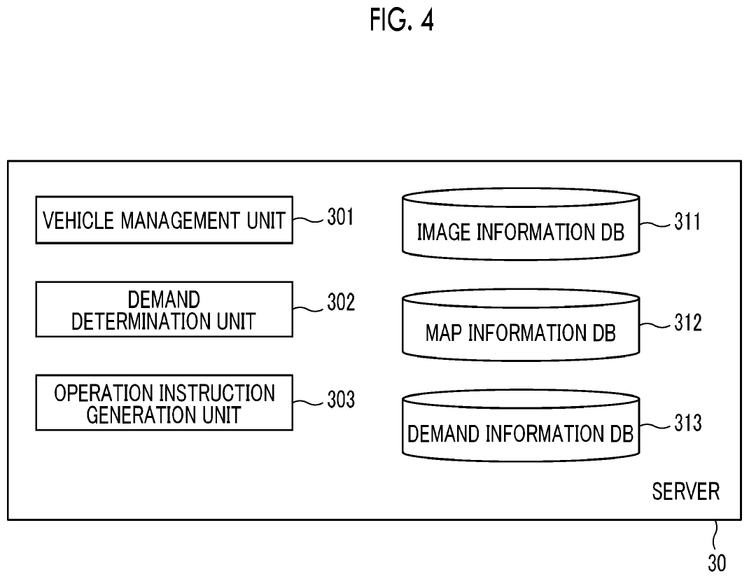

FIG. 4 is a diagram illustrating an example of the functional configuration of the server 30. The server 30 includes a vehicle management unit 301, a demand determination unit 302, an operation instruction generation unit 303, an image information DB 311, a map information DB 312, and a demand information DB 313 as functional constituent elements. The vehicle management unit 301, the demand determination unit 302, and the operation instruction generation unit 303 are functional constituent elements provided when the processor 31 of the server 30 executes various programs stored in the auxiliary storage unit 33, for example.

The image information DB 311, the map information DB 312, and the demand information DB 313 are, for example, relational databases organized when a database management system (DBMS) program executed by the processor 31 manages data stored in the auxiliary storage unit 33. Note that, any of the functional constituent elements of the server 30 or a part of processes thereof may be executed by another computer connected to the network N1.

The vehicle management unit 301 manages various items of information relating to the vehicle 10. The vehicle management unit 301 acquires and manages position information that is transmitted from the vehicle 10 each time a predetermined period elapses or position information that is transmitted from the vehicle 10 in response to a request from the server 30. In addition, the vehicle management unit 301 acquires and manages image data transmitted from the vehicle 10. The vehicle management unit 301 stores position information, time information, and image data into the image information DB 311 with the position information, the time information, and the image data being correlated with a vehicle ID.

The demand determination unit 302 determines the demand for the curtains 50 at a place relating to position information or an area including the place based on the position information and image data. The demand determination unit 302 analyzes images obtained by imaging the curtains 50 and counts the number of times that a consumer touches the curtains 50. The demand for each curtain 50 is determined based on the result of the count and information indicating the demand for each curtain 50 is stored in the demand information DB 313 with the demand for each curtain 50 being correlated with the position information and time information.

The operation instruction generation unit 303 generates a moving route such that the vehicle 10 patrols via a predetermined place, for example. The operation instruction generation unit 303 generates the moving route based on map information stored in the map information DB 312, which will be described later. The moving route is generated such that the moving route becomes a route according to a rule determined in advance. The operation instruction generation unit 303 transmits an operation instruction including the moving route to the vehicle 10.

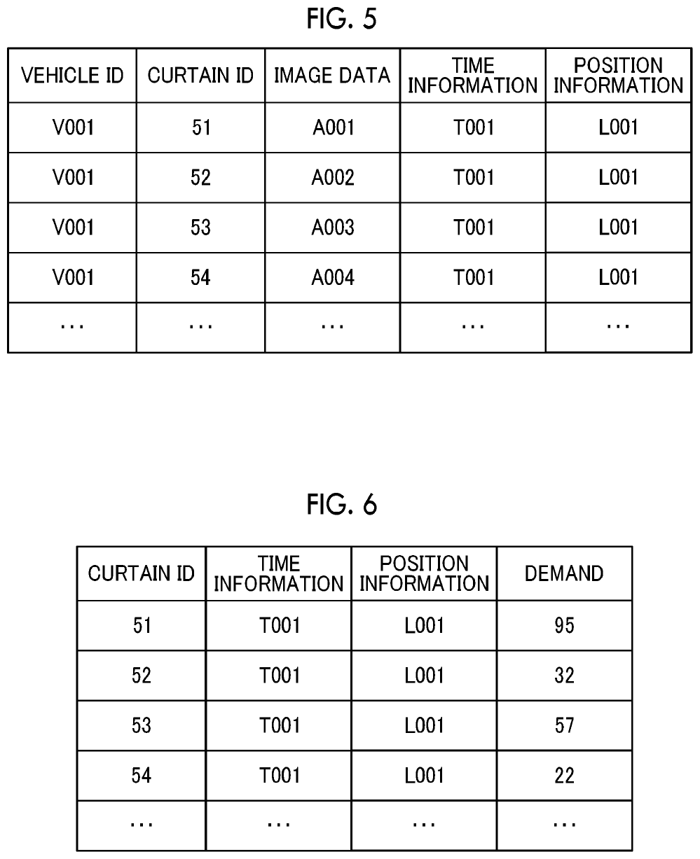

The image information DB 311 is formed with image data, time information, and position information as described above being stored in the auxiliary storage unit 33. Here, the configuration of image information stored in the image information DB 311 will be described based on FIG. 5. FIG. 5 is a diagram illustrating a table configuration of the image information. An image information table includes fields for vehicle IDs, curtain IDs, image data, time information, and position information. In a vehicle ID field, information for specifying the vehicle 10 is input. In a curtain ID field, information for specifying the curtain 50 is input. Note that, the curtain IDs shown in FIG. 5 correspond to the reference numerals of the curtains 51, 52, 53, 54 shown in FIG. 2. In an image data field, information for specifying image data corresponding to a curtain ID is input. In a time information field, information for specifying a time at which an image is captured is input. In a position information field, information for specifying a position at which an image is captured is input.

In the map information DB 312, map information including map data and point of interest (POI) information such as texts or photographs indicating the features of each point in the map data is stored. Note that, the map information DB 312 may be provided from another system connected to the network N1 (for example, geographic information system (GIS)).

The demand information DB 313 is formed with demand information stored in the auxiliary storage unit 33 and in the demand information DB 313, curtain IDs and demand information are associated with each other. Here, the configuration of demand information stored in the demand information DB 313 will be described based on FIG. 6. FIG. 6 is a diagram illustrating a table configuration of the demand information. A demand information table includes fields for curtain IDs, time information, position information, and demand. In a curtain ID field, information for specifying the curtain 50 is input. In a time information field, information for specifying a time corresponding to a demand is input. In a position information field, information for specifying a position corresponding to a demand is input. In a demand field, a value obtained by indexing a demand is input. For example, the demand determination unit 302 analyzes image data stored in the image information DB 311 and counts the number of times that a consumer touches the curtains 50 for each curtain 50. The numbers obtained by the count are input as values obtained by indexing demands. It is considered that the larger the value of demand is, the more the consumer is interested in the curtain 50. Therefore, it can be said that the larger the value of demand is, the greater the demand for the curtain 50 is. Note that, any of the length of a time for which the curtain 50 is touched, the length of a time for which the curtain 50 is seen, and the number of times that the curtain 50 is seen may also be input as a value obtained indexing the demand of a consumer.

Functional Configuration: Vehicle

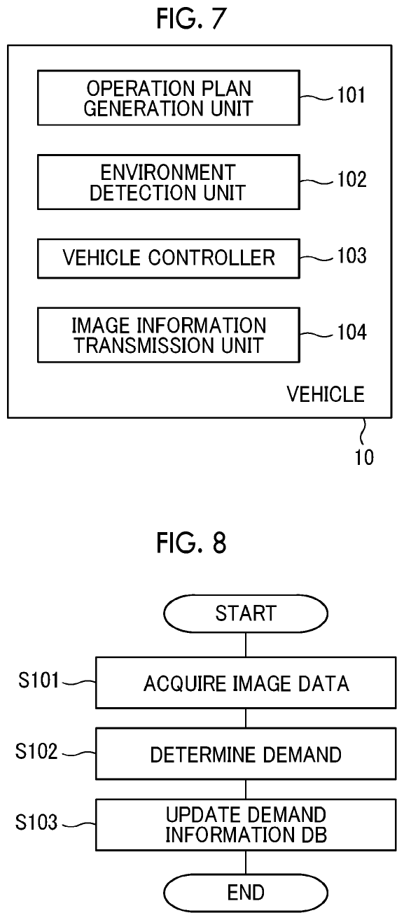

FIG. 7 is a diagram illustrating an example of the functional configuration of the vehicle 10. The vehicle 10 includes an operation plan generation unit 101, an environment detection unit 102, a vehicle controller 103, and an image information transmission unit 104 as functional constituent elements. The operation plan generation unit 101, the environment detection unit 102, the vehicle controller 103, and the image information transmission unit 104 are functional constituent elements provided when the processor 11 of the vehicle 10 executes various programs stored in the auxiliary storage unit 13, for example.

The operation plan generation unit 101 acquires an operation instruction from the server 30 and generates an operation plan of the vehicle 10. The operation plan generation unit 101 calculates a moving route of the vehicle 10 based on the operation instruction from the server 30 and generates an operation plan of moving along the moving route.

The environment detection unit 102 detects the surrounding environment around the vehicle 10 needed for autonomous travel based on data acquired by the environment information sensor 18. Examples of a target to be detected include the number of lanes or the positions of lanes, the number of other moving objects present in the vicinity of the vehicle 10 or the positions of the other moving objects, the number of obstacles (for example, pedestrian, bicycle, structure, and building) present in the vicinity of the vehicle 10 or the positions of the obstacles, the structure of a road, and a traffic sign. However, the target to be detected is not limited thereto. The target to be detected may be any type of target that needs to be detected for autonomous travel. For example, in a case where the environment information sensor 18 is a stereo camera, data of an image captured by the stereo camera is subject to image processing such that an object in the vicinity of the vehicle 10 is detected. Data about the surrounding environment around the vehicle 10 detected by the environment detection unit 102 (hereinafter, referred to as environment data) is transmitted to the vehicle controller 103 which will be described later.

The vehicle controller 103 generates a control instruction to control autonomous travel of the vehicle 10 based on an operation plan generated by the operation plan generation unit 101, environment data generated by the environment detection unit 102, and position information of the vehicle 10 acquired by the position information sensor 17. For example, the vehicle controller 103 generates the control instruction such that the vehicle 10 travels along a predetermined route and travels without an obstacle entering a predetermined safety area centering on the vehicle 10. The generated control instruction is transmitted to the drive unit 19. As a method of generating a control instruction for causing the vehicle 10 to autonomously travel, a known method can be adopted.

The image information transmission unit 104 transmits image data to the server 30. The image information transmission unit 104 transmits the data of images captured by the cameras 60 to the server 30 via the communication unit 16 with the data of the images being correlated with position information acquired from the position information sensor 17 and time information at that time. The timing of transmission of image data from the image information transmission unit 104 can be appropriately set. For example, the transmission may be performed periodically, may be performed at the timing of transmission of some information to the server 30, and may be performed in response to a request from the server 30. The image information transmission unit 104 transmits the image data to the server 30 along with identification information (vehicle ID) for uniquely identifying the host vehicle. Note that, a vehicle ID for identifying the vehicle 10 is assigned in advance.

Flow of Process: Server

Next, a process in which the server 30 creates the demand information DB 313 will be described. FIG. 8 is an example of a flowchart of a process of creating the demand information DB 313 according to the present embodiment. The process shown in FIG. 8 is performed by the processor 31 of the server 30 each time a predetermined time elapses. Note that, here, it will be assumed that the server 30 has already received, from the vehicle 10, information needed in organizing the image information DB 311. The present routine is performed for each record of the image information DB 311.

In step S101, the demand determination unit 302 acquires image data by referring to the image information DB 311. Next, in step S102, the demand determination unit 302 determines a demand based on the image data. The demand determination unit 302 counts the number of times that a consumer touches the curtains 50 and indexes demand. Then, in step S103, the demand determination unit 302 stores the indexed demand in the demand information DB 313 with the indexed demand being correlated with time information and position information.

Flow of Process: Vehicle

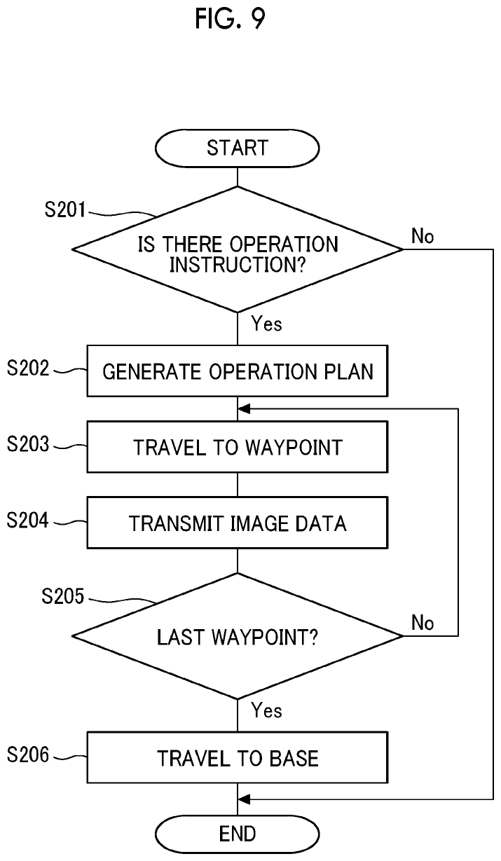

Next, a process in the vehicle 10 will be described. FIG. 9 is an example of a flowchart of the process in the vehicle 10 according to the present embodiment. The process shown in FIG. 9 is performed by the processor 11 of the vehicle 10 each time a predetermined time elapses.

In step S201, determination on whether the operation plan generation unit 101 has received an operation instruction from the server 30 or not is performed. In a case where the result of the determination in step S201 is positive, the process proceeds to step S202 and in a case where the result of the determination in step S201 is negative, the present routine is terminated. In step S202, the operation plan generation unit 101 generates an operation plan in accordance with the operation instruction. When generation of the operation plan is finished, the vehicle controller 103 generates a control instruction, the drive unit 19 is controlled by the control instruction, and the vehicle 10 travels to a waypoint (predetermined place) in step S203.

In step S204, the image information transmission unit 104 transmits image data to the server 30, the image data being correlated with position information and time information. When a predetermined time elapses thereafter, the process proceeds to step S205, for example. Next, in step S205, the vehicle controller 103 determines whether the current position of the vehicle 10 is the last waypoint or not. In a case where the result of the determination in step S205 is positive, the process proceeds to step S206 and in a case where the result of the determination in step S205 is negative, the process returns to step S203 and the vehicle 10 is caused to travel to the next waypoint. In step S206, the vehicle controller 103 causes the vehicle 10 to travel to a base and the present routine is terminated thereafter.

Note that, demand information stored in the demand information DB 313 can be appropriately used by a predetermined user. For example, since it is possible to grasp demand in each region for each time, a large number of curtains 50 for which the demand is high may be loaded onto the vehicle 10 and the curtains 50 for which the demand is high may be sold at a corresponding area at a corresponding time. In this case, the higher the demand for the curtain 50 is, the larger the number of the curtains 50 loaded onto the vehicle 10 may be and a curtain for which the demand is lower than a predetermined value may not be loaded onto the vehicle 10. Accordingly, it is possible to restrain products for which the demand is high from being sold out.

As described above, according to the present embodiment, it is possible to determine the demand for a product by using the autonomously traveling vehicle 10. Accordingly, it is possible to increase the sales.

### Other Embodiment

The above-described embodiments are merely examples and the disclosure can be implemented with appropriate modifications without departing from the gist of the disclosure.

In the above-described embodiments, the description has been made focusing on the demand for the curtains 50. However, the disclosure is not limited thereto and determination can be performed in the same manner with respect to the demand for other products. In addition, in the above-described embodiments, demand is determined based on the number of times that an article (curtain 50) is touched. However, the disclosure is not limited thereto and demand may be determined based on the length of a time for which an article is touched, for example. That is, it can be considered that the longer the length of a time for which a consumer touches an article is, the more the consumer is interested in the article. Therefore, the longer the length of a time for which a consumer touches an article is, the higher the demand for the article can be determined as being.

In addition, in the above-described embodiments, images of the inside of the vehicle 10 are captured by the cameras 60 and the demand for a product is determined based on data of the images. However, a method of determining the demand for a product is not limited thereto. For example, it is possible to detect that a consumer has halted in front of a product with a mass measuring sensor provided on a floor of the vehicle 10. In addition, it is possible to determine that the consumer is interested in the product when the consumer halts in front of the product. Accordingly, it is possible to determine that the demand for a product is high in accordance with the number of times that a consumer halts in front of the product and the length of a time for which the consumer stays in front of the product. In addition, a load sensor may detect that a consumer has touched a product, for example.

In addition, for example, the cameras 60 may detect the line of sight of a consumer and a determination may be made that the consumer is interested in a product looked by the consumer and the demand for the product is high. In this case, the larger the number of times that a consumer sees a product is high, the higher the demand for the product may be determined as being and the longer the length of a time for which a consumer sees a product is, the higher the demand may be determined as being.

In addition, it is also possible to determine the demand for a product displayed by means of an advertisement disposed on an outer wall of the vehicle 10 in addition to a product exhibited inside the vehicle 10, for example. For example, a camera imaging the outside of the vehicle 10 may be provided such that the camera detects the line of sight of a consumer present outside the vehicle 10 and a determination is made that the consumer is interested in a product looked by the consumer and the demand for the product is high. A product relating to an advertisement is not limited to an article and may be a service. In this case, the larger the number of times that a consumer sees an advertisement, the higher the demand for a product relating to the advertisement may be determined as being. Alternatively, the longer the length of a time for which a consumer sees an advertisement, the higher the demand for a product relating to the advertisement may be determined as being.

In addition, a sensor measuring the body temperature or the pulse rate of a consumer may be provided in the vehicle 10 such that a determination is made that there is a high demand when the body temperature or the pulse rate of the consumer is increased.

The processes or means described in the disclosure can be freely combined with each other as long as there is no technical contradiction.

In addition, a process that has been described as a process performed by one device may be divided up and performed by a plurality of devices. Alternatively, a process that has been described as a process performed by different devices may be performed by one device. It is possible to flexibly change with what kind of hardware configuration (server configuration) each function is realized in a computer system. In the above-described embodiments, the server 30 includes the vehicle management unit 301, the demand determination unit 302, the operation instruction generation unit 303, the image information DB 311, the map information DB 312, and the demand information DB 313 as functional constituent elements. However, a part or all of the functional constituent elements may be included in the vehicle 10. For example, the vehicle 10 may determine the demand for a product.

The disclosure also can be realized when a computer program, in which the functions described in the above-described embodiments are mounted, is supplied to a computer and one or more processors of the computer reads and executes the program. Such a computer program may be provided to a computer via a non-temporal computer-readable storage medium that can be connected to a system bus of the computer and may be provided to the computer via a network. Examples of the non-temporal computer-readable storage medium include any type of disk such as a magnetic disk (floppy (registered trademark) disk, hard disk drive (HDD), or like) and an optical disk (CD-ROM, DVD disk, Blu-ray disk, or like), a read-only memory (ROM), a random access memory (RAM), an EPROM, an EEPROM, a magnetic card, a flash memory, an optical card, and any type of medium suitable for storing electronic commands.

What is claimed is:

1. An information processing apparatus comprising a controller configured to
determine a demand of a consumer for a product based on a behavior of the consumer that is detected in a moving object configured to autonomously travel based on an operation instruction and move the product or an advertisement for the product to a predetermined place; and
store a result of the determination about the demand into a storage unit with the result of the determination being correlated with the predetermined place.

2. The information processing apparatus according to claim 1, wherein the controller stores the result of the determination about the demand into the storage unit with the result of the determination being correlated with a time in addition to the predetermined place.

3. The information processing apparatus according to claim 1, wherein the controller determines the demand based on a behavior of the consumer that is imaged by a camera provided in the moving object.

4. The information processing apparatus according to claim 1, wherein the controller determines the demand based on the number of times that the consumer touches the product or a length of a time for which the consumer touches the product.

5. The information processing apparatus according to claim 1, wherein the controller determines the demand based on the number of times that the consumer sees the product or the advertisement or a length of a time for which the consumer sees the product or the advertisement.

6. An information processing method comprising:
determining a demand of a consumer for a product based on a behavior of the consumer that is detected in a moving object configured to autonomously travel based on an operation instruction and move the product or an advertisement for the product to a predetermined place; and
storing a result of the determination about the demand into a storage unit with the result of the determination being correlated with the predetermined place.

7. A program causing a computer to
determine a demand of a consumer for a product based on a behavior of the consumer that is detected in a moving object configured to autonomously travel based on an operation instruction and move the product or an advertisement for the product to a predetermined place, and
store a result of the determination about the demand into a storage unit with the result of the determination being correlated with the predetermined place.

8. A demand search system comprising:
a moving object configured to autonomously travel based on an operation instruction and move a product or an advertisement for the product to a predetermined place; and
a server configured to output the operation instruction to the moving object, wherein:
the moving object is provided with a behavior detection device configured to detect a behavior of a consumer and a position detection device configured to detect position information of the moving object;
the server is provided with a demand determination unit configured to determine a demand of the consumer for the product based on the behavior of the consumer that is detected by the behavior detection device and a storage unit configured to store a result of the determination performed by the demand determination unit with the result of the determination being correlated with the position information of the moving object that is detected by the position detection device.
